(19) United States
(12) Patent Application Publication
(10) Pub. No.: US 2015/0269387 A1
(43) Pub. Date: Sep. 24, 2015

(54) Methods and Systems of Preventing An Automated Routine from Passing a Challenge-Response Test

(71) Applicant: QUALCOMM Incorporated, San Diego, CA (US)

(72) Inventor: Umberto Cannarsa, San Diego, CA (US)

(21) Appl. No.: 14/658,310

(22) Filed: Mar. 16, 2015

Related U.S. Application Data
(60) Provisional application No. 61/954,986, filed on Mar. 18, 2014.

(51) Int. Cl. G06F 21/62; H04L 9/32

(52) U.S. Cl. CPC G06F 21/62; H04L 9/3271

(57) ABSTRACT

The various embodiments enable the prevention of an automated computer routine from passing a challenge-response test. A processor may generate a first character string and create a first image comprising first characters based on the first character string, and may generate a second character string and create a second image comprising second characters based on the second character string. The processor may create a third image by superimposing the first image and the second image. The processor may associate at least one decoy code with the third image, the at least one decoy code based on character(s) within the third image that are likely to be detected by an automatic character recognition process. The processor may present the third image as a verification challenge, and may determine that the verification challenge is failed in response to receiving a verification challenge response that matches the decoy code.

### RELATED APPLICATIONS

This application claims the benefit of priority to U.S. Provisional Patent Application No. 61/954,986 entitled “Methods And Systems Of Preventing An Automated Routine From Passing A Challenge-Response Test” filed Mar. 18, 2014, assigned to the assignee hereof, the entire contents of which are hereby incorporated by reference in their entirety.

### BACKGROUND

Computing services that gather information from user input, such as an online poll, a registration for a free email address, receiving a registration for an event, and the like, may be subject to abuse by computer automated routines. For example, a web robot, or bot, can repeatedly perform tasks such as providing input to a computing service that gathers information, at a much higher rate than would be possible for a human user. Techniques to reduce the effectiveness of such automated routines include challenge-response tests in which a correct response to a challenge (e.g., a request for certain input) is relatively difficult for the automated routine to determine while being relatively easy for a human user to determine. One example of such a challenge-response test is CAPTCHA (Completely Automated Public Turing Test To Tell Computers and Humans Apart), which typically presents an image of distorted text (such as letters, numbers, punctuation, or other characters) with a busy background such as lines, drawings, and the like, to make the distorted text difficult to detect by a non-human user. However, increasingly sophisticated automated routines may be developed that are able to detect the distorted text of a conventional CAPTCHA.

### SUMMARY

### Brief Description of the Drawings

The accompanying drawings, which are incorporated herein and constitute part of this specification, illustrate exemplary embodiments, and together with the general description given above and the detailed description given below, serve to explain the features of the invention.

FIG. 1 illustrates a block diagram of an example computing device configured to execute methods of preventing an automated computer routine from passing a challenge-response test.

FIG. 2 illustrates a process flow diagram of an example method of preventing an automated computer routine from passing a challenge-response test.

FIG. 3 illustrates a process flow diagram of another example method of preventing an automated computer routine from passing a challenge-response test.

FIGS. 4A-4G illustrate exemplary images that may be presented as a verification challenge.

FIG. 5 illustrates a component diagram of an example server suitable for implementing the various aspects.

### SUMMARY

Systems, methods, and devices of the various embodiments provide processes for generating a CAPTCHA (Completely Automated Public Turing Test To Tell Computers and Humans Apart) challenge-response test that is more difficult for an automated computer routine to defeat. Embodiment methods may include generating a first character string and creating a first image comprising first characters based on the first character string, generating a second character string and creating a second image comprising second characters based on the second character string, creating a third image by superimposing the first image and the second image, associating a first character code based on the first character string with the third image, associating at least one decoy code with the third image, wherein the at least one decoy code is based on one or more characters within the third image that are likely to be detected by an automatic character recognition process, presenting the third image as a verification challenge, and determining, by the computing device, that the verification challenge is failed in response to receiving a verification challenge response that matches the decoy code.

In some embodiments, the first characters of the first image may be configured to be unlikely to be detected by an automatic character recognition process. In some embodiments, the first characters of the first image may be presented in at least one of different orientations, different shapes, different sizes, different typefaces, and differing numbers of characters than the second characters of the second image to make the first characters difficult to detect by a computer automated routine. In some embodiments, generating the second character string may include generating a substantially random sequence of characters. In some embodiments, generating the second character string may include in the substantially random sequence of characters at least one character string configured to be detected by an automatic character recognition process attempting to defeat a Completely Automated Public Turing Test To Tell Computers and Humans Apart (CAPTCHA) challenge, and wherein the decoy code represents the at least one character string included in the second character string.

Some embodiments may include analyzing the substantially random sequence of characters to identify at least one character string that is likely to be recognized by an automatic character recognition process attempting to defeat a Completely Automated Public Turing Test To Tell Computers and Humans Apart (CAPTCHA) challenge, wherein the decoy code represents the identified at least one character string. In some embodiments, analyzing the substantially random sequence of characters may include analyzing the substantially random sequence of characters to identify at least one word appearing within the random sequence of characters.

Some embodiments may include analyzing the third image to identify at least one character string that is likely to be recognized by an optical character recognition process attempting to defeat a Completely Automated Public Turing Test To Tell Computers and Humans Apart (CAPTCHA) challenge-response test, wherein the decoy code represents the identified at least one character string. In some embodiments, analyzing the third image to identify the at least one character string may include analyzing the third image to identify at least one word appearing within the third image formed by characters from the first image, the second image, or characters formed by a combination of characters from the first image and the second image.

In some embodiments, creating the third image by superimposing the first image and the second image may include creating the third image so that at least one character is formed from superimposition of characters within the first and second images that is configured to be detected by an automatic character recognition process. Some embodiments may include determining that the verification challenge is passed in response to receiving a verification challenge response that matches the first character code. In some embodiments, creating a third image by superimposing the first image and the second image may include creating the third image by superimposing the first image at a randomly selected location on the second image.

Further embodiments include a computing device including a processor configured with processor-executable instructions to perform operations of the embodiment methods described above. Further embodiments include a non-transitory processor-readable storage medium having stored thereon processor-executable software instructions configured to cause a processor to perform operations of the embodiment methods described above. Further embodiments include a computing device that includes means for performing functions of the operations of the embodiment methods described above.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the claims.

The word “exemplary” is used herein to mean “serving as an example, instance, or illustration.” Any implementation described herein as “exemplary” is not necessarily to be construed as preferred or advantageous over other implementations.

The terms “computer,” and “computing device” are used interchangeably herein to refer to any programmable computer, server or processor that can be configured with programmable instruction to perform the embodiment methods.

As used in this application, the terms “component,” “module,” “system,” “engine,” “manager” and the like are intended to include a computer-related entity, such as, but not limited to, hardware, firmware, a combination of hardware and software, software, or software in execution, which are configured to perform particular operations or functions. For example, a component may be, but is not limited to, a process running on a processor, a processor, an object, an executable, a thread of execution, a program, and/or a computer. By way of illustration, both an application running on a computing device and the computing device may be referred to as a component. One or more components may reside within a process and/or thread of execution and a component may be localized on one processor or core and/or distributed between two or more processors or cores. In addition, these components may execute from various non-transitory computer readable media having various instructions and/or data structures stored thereon. Components may communicate by way of local and/or remote processes, function or procedure calls, electronic signals, data packets, memory read/writes, and other known computer, processor, and/or process related communication methodologies.

Computer automated routines, such as a web robot, or bot, can be used to repeatedly perform tasks such as providing input to a computing service that gathers information at a much higher rate than would be possible for a human user. Bots can thus be used to abuse or game an online poll, a registration for a free email address, receiving a registration for an event, and the like. Techniques to distinguish between a human user and an automated computer routine such as a bot include challenge-response tests in which a correct response to a challenge (e.g., a request for certain input) is relatively difficult for the automated routine to determine while being relatively easy for a human user to determine One example of such a challenge-response test is CAPTCHA (Completely Automated Public Turing Test To Tell Computers and Humans Apart), which typically presents an image of distorted text (such as letters, numbers, punctuation, or other characters) with a busy background such as lines, drawings, and the like, to make the distorted text difficult to detect by a non-human user. Increasingly sophisticated automated routines may be developed that are able to detect the distorted text of a conventional CAPTCHA, and thus further techniques of preventing an automated computer routine from passing a challenge-response test are desirable.

The various embodiments include methods, and computing devices configured to implement the methods, of preventing an automated computer routine from passing a challenge-response test. By increasing the complexity of a challenge-response test and including one or more “decoy codes,” the various embodiments improve the ability of a computing device to distinguish an input received from a human user and an input received from a computer-automated routine. In an embodiment, the computing device may be configured to generate a first character string and to create a first image including first characters based on the first character string. The computing device may also be configured to generate a second character string and create a second image including second characters based on the second character string. In some embodiments, the second character string may include one or more decoy strings or codes that is either generated or recognized within the generated string. At least one of the first character string and the second character string may include substantially random characters.

The computing device may combine the first and second images to create a third image by superimposing at least a portion of the first image and a portion of the second image, and to associate a character code and one or more decoy codes with the third image. The character code associated with the third image may be a grouping of human-recognizable characters within the image, such as letters, numbers, and punctuation. The term “decoy code” is used herein to refer to a character string (e.g., letters, numbers and punctuation) within the third image that is selected or generated as likely to be “recognized” by a program attempting to defeat a CAPTCHA challenge. For example, a decoy code may be represented by a string of characters within the third image that are clear and thus easy for a text-recognition algorithm to identify, but different from the character code that a human is likely to recognize as the correct response (i.e., characters associated with the character code). In one example, the characters representing a decoy code may form a word or phrase that belongs to a dictionary or is otherwise recognized as a recognizable word or phrase. The first characters of the first image may further include a different orientation, a different shape, a different size, and/or a different typeface than the second characters of the second image, so that the third image may include a combination of human recognizable characters of varying orientations, shapes, sizes, typefaces, and the like.

The computing device may be configured to present the third image as a verification challenge to determine whether a user is a human user or an automated computer routine with the character code associated with the third image used as the correct CAPTCHA response, and one or more decoy codes associated with the third image as an incorrect response (i.e., an indication that the user is not a human). In an embodiment, the character code may be based on the first character string, and the one or more decoy codes may be based on the second character string. In another example, the character code and/or one or more decoy codes may be based on characters from a combination of the first character string and second character string. The character code and the one or more decoy codes may be used by a computing device to determine whether a received input was entered by a human when the received input matches the character code. For example, the third image may be relatively complex for a computer-automated routine to discern differences among the characters presented in the third image (i.e., the combination of the characters of the first image and the characters of the second image), while such differences may be readily apparent to a human user. Further, the third image may include a portion that is relatively easily detected by an automated computer routine. Receipt by the computing device of an input matching a character code may be determined as a verification success, and thus an indication that the user is a human user. Receipt by the computing device of an input matching one or more decoy codes may be determined as an indication that the user is not human (i.e., is an automated computer routine) and thus a verification failure.

The computing device may be further configured to recognize an attempt by a program to defeat a CAPTCHA challenge when the received input matches one or more decoy codes associated with the third image. For example, a decoy code may be a character string different from the character string on which the character code is based. A decoy code may include at least one character configured to be detected by an optical or character recognition algorithm, such as may be used by a computer automated routine attempting to defeat a CAPTCHA challenge. Multiple decoy codes may be associated with the third image and receipt by the computing device of an input matching any of the one or more decoy codes may prompt the computing device to reject the verification attempt and conclude that input was from a computer automated routine attempting to defeat the CAPTCHA challenge.

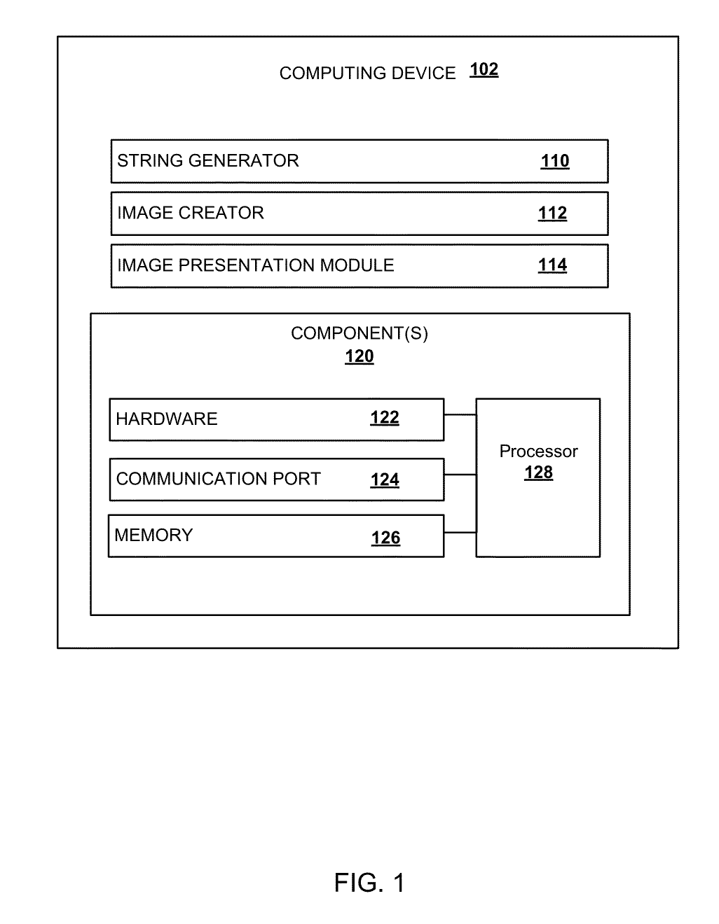

FIG. 1 illustrates an embodiment computing device 102 configured to prevent an automated computer routine from passing a challenge-response test. The computing device may include various components 120 typical of computing devices, including hardware 122 components, a communication port 124, and a memory 126 component.

The computing device 102 may further include a string generator 110, an image creator 112, and an image presentation module 114. These modules 110-114 may be implemented in software as software modules executing on a processor of the computing device to perform the various methods, in hardware, or a combination of software modules and hardware components. Each of these modules 110-114 may be implemented as a thread, process, daemon, module, software application, sub-system, or component. When implemented in software, the modules 110-114 may be implemented within parts of the operating system (e.g., within the kernel, in the kernel space, in the user space, etc.), within separate programs or applications, in specialized hardware buffers or processors, or any combination thereof. In an aspect, one or more of the modules 110-114 may be implemented as software instructions executing on one or more processors 128 of the computing device 102 as described more fully below.

The string generator 110 may include processor-executable instructions configured to generate a character string, which may include letters, numbers, punctuation, ideograms, and the like. The characters of the character string may be human readable, and thus may include characters from any human readable language. For example, the characters may include letters from the Roman alphabet, Arabic numerals, characters from a non-Roman alphabet (e.g., Chinese, Japanese, or Korean characters, whether ideograms or phonetic characters), punctuation from one or more alphabets, and the like. The string generator 110 may generate more than one character string, such as a first character string and a second character string. At least one of the first character string and the second character string may include substantially random characters. Additionally, or alternatively, at least one of the first character string and the second character string may be selected from a list of character strings.

The image creator 112 may include processor-executable instructions configured to create an image including characters based on a character string generated by the string generator 110. The image creator 112 may include processor-executable instructions configured to create a first image including first characters based on the first character string generated by the string generator 110, and to create a second image including second characters based on the second character string generated by the string generator 110. The image creator 112 may further include processor-executable instructions configured to create a third image by superimposing the first image and the second image. The first and second images may be partially superimposed or completely superimposed, in order to create an image including a combination of characters of the first character string and characters of the second character string. The image creator 112 may further include processor-executable instructions configured to select a random location on the second image, and to superimpose the first image on the second image at the randomly selected location. The first image and the second image created by the image creator 112 may include different orientations, different shapes, different sizes, different typefaces, and/or a different number of characters. The first image and the second image are typically created in a file format or image format that is not readily parsed by an automated computer routine, rather than in a text format or data format that is readily susceptible to parsing by an automated computer routine.

The image creator 112 may further include processor-executable instructions configured to associate a character code and a decoy code (or multiple character codes or decoy codes) with the third image. The character code and the decoy code(s) may be based on the first character string and/or the second character string. As the first image and the second image created by the image creator 112 may include different orientations, different shapes, different sizes, different typefaces, or differing numbers of characters, at least one difference between the characters of the first image and the characters of the second image may be readily apparent to a human user, while such difference may be relatively difficult for a computer automated routine to discern. For example, the first image may include relatively few characters presented in a boldface type, and the second image may include relatively many characters in a non-boldface type, some of which may include one or more decoy codes. In such cases, due to the relative prominence of the boldface characters of the first image, image creator 112 may associate a character code with the third image based on the first character string. Other examples are also possible.

The image presentation module 114 may include processor-executable instructions configured to present the third image as a verification challenge as part of a challenge-response test. For example, the computing device 102 may be used to access a service that solicits input from a user, such as an online poll, a registration for a free email address, a comment on an article, web log, or other publication, a registration for an event, and so forth. The image presentation module 114 may present the third image as a verification challenge to request certain input. The requested input may be indicated by the third image itself, such as by a difference in the presentation of the characters of the first image and the characters of the second image that is readily apparent to a human user, yet relatively difficult to detect for a computer automated routine.

The image presentation module 114 may further include processor-executable instructions configured to determine whether the received input corresponds with the character code associated with the third image. Receipt by the image presentation module 114 of an input matching the character code may be determined as a verification success, and thus an indication that the user is a human user.

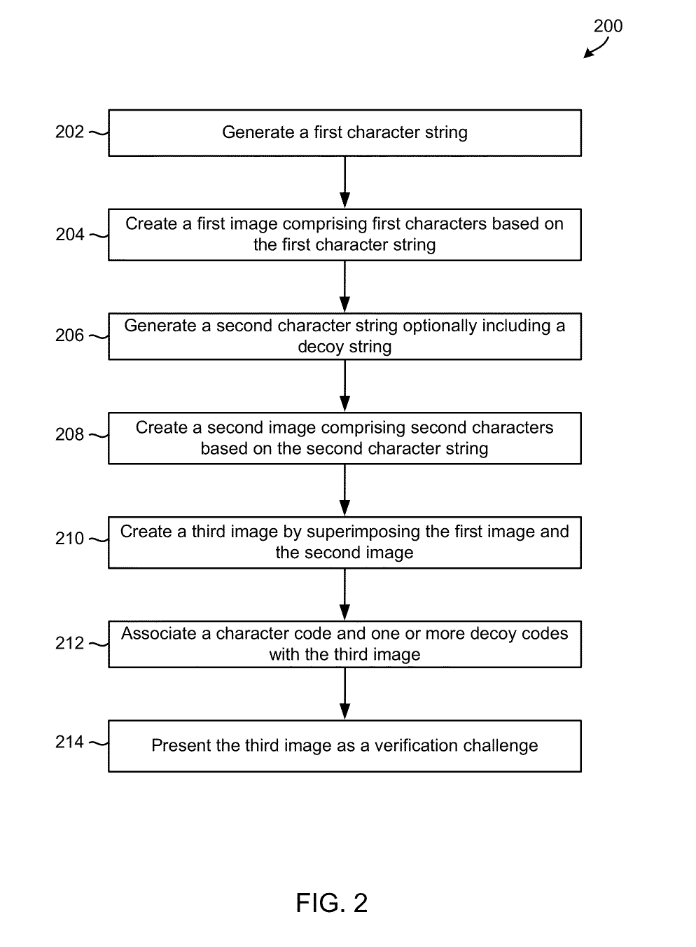

FIG. 2 illustrates a process flow diagram of an example method 200 that may be used by exemplary computing device 102 to prevent an automated computer routine from passing a challenge-response test. In block 202, the computing device 102 may generate a first character string. The character string may include letters, numbers, punctuation, ideograms, and other characters. The characters of the character string may be human readable, and thus may include characters from any human readable language. In an embodiment, the generated first character string may include a random sequence of characters. In block 204, the computing device 102 may create a first image including first characters based on the first character string.

In block 206, the computing device 102 may generate a second character string, which, similar to the first character string, may include human readable letters, numbers, punctuation, ideograms, and other characters, which may optionally include one or more decoy strings. In an embodiment, the generated second character string may be a random sequence of characters different from the first character string. Instead of generating one or more decoy strings, the computing device 102 may inspect the generated second character string (or a combination of the first string and second character string) and recognize or select one or more sequences within the string(s) that are likely to be recognized as a potential CAPTCHA code by a computer program (e.g., a bot) attempting to defeat a CAPTCHA challenge, which may be then used as the decoy string(s). In some embodiments, a substantially random sequence of characters may be included in the generated second character string. The substantially random sequence of characters may include at least one character string configured to be detected by an automatic character recognition process attempting to defeat a Completely Automated Public Turing Test To Tell Computers and Humans Apart (CAPTCHA) challenge. In some embodiments, the decoy code(s) may represent the at least one character string included in the second character string. In some embodiments, generating the second character string may include analyzing the substantially random sequence of characters to identify at least one character string that is likely to be recognized by an automatic character recognition process attempting to defeat a CAPTCHA challenge, and using the identified character string as the decoy code. In some embodiments, analyzing the substantially random sequence of characters may include analyzing the substantially random sequence of characters to identify at least one word appearing within the random sequence of characters.

In block 208, the computing device 102 may create a second image including second characters based on the second character string.

In block 210, the computing device 102 may create a third image by superimposing the first image and the second image. The first image and the second image may include different orientations, different shapes, different sizes, different typefaces, or differing numbers of characters, to provide at least one difference between the characters of the first image and the characters of the second image that are readily apparent to a human user while being relatively difficult for a computer automated routine to discern. Further, the difference between the first and second images may make one set of characters (e.g., the characters of the first image) relatively more prominent or visually distinct from the other set of characters (e.g., the characters of the second image). At least one of the first character string and the second character string may include substantially random characters. Additionally or alternatively, at least one of the first character string and the second character string may be selected from a list of character strings. In some embodiments, the characters of the first character string represented by the first image may be presented in different orientations, different shapes, different sizes, different typefaces, and/or differing numbers of characters to make the characters of the first character string difficult to detect by a computer automated routine (e.g., a character recognition routine, or an optical character recognition routine). In some embodiments, in order to make the characters of the first character string difficult to detect by a computer automated routine, the presentation of the characters of the first character string may be configured such that a computer automated routine would have to perform image analysis and interpretation beyond that typically performed in a character recognition routine or optical character recognition routine in order to be able to recognize the first characters. In some embodiments, creating the third image by superimposing the first image and the second image may include creating the third image so that at least one character is formed from superimposition of characters within the first and second images that is configured to be detected by an automatic character recognition process (i.e., a decoy). The first and second images may be partially superimposed or completely superimposed, such that the resulting third image includes a combination of characters of the first character string and characters of the second character string. In an embodiment, the computing device 102 may select a random location on the second image and superimpose the first image on the second image at the randomly selected location.

The computing device 102 may associate a character code and one or more decoy codes with the third image in block 212. The character code may be based on the first character string or the second character string. In one example, the character code may include the characters of the first character string included in the first image. The character code may be based on a difference between the first and second images that makes one set of characters (e.g., the characters of the first image) relatively more prominent or visually distinct from the other set of characters (e.g., the characters of the second image), such as a difference in orientations, shapes, sizes, typefaces, or numbers of characters. The at least one difference between the characters of the first image and the characters of the second image may be readily apparent to a human user, while such difference may be relatively difficult for a computer automated routine to discern. In one example, more than one character code may be associated with the third image. For example, the third image may be generated by superimposing additional images onto the first and second image, and/or by selecting a random set of characters from the characters in the first image and/or characters in the second image, or a combination thereof as characters representing multiple character codes.

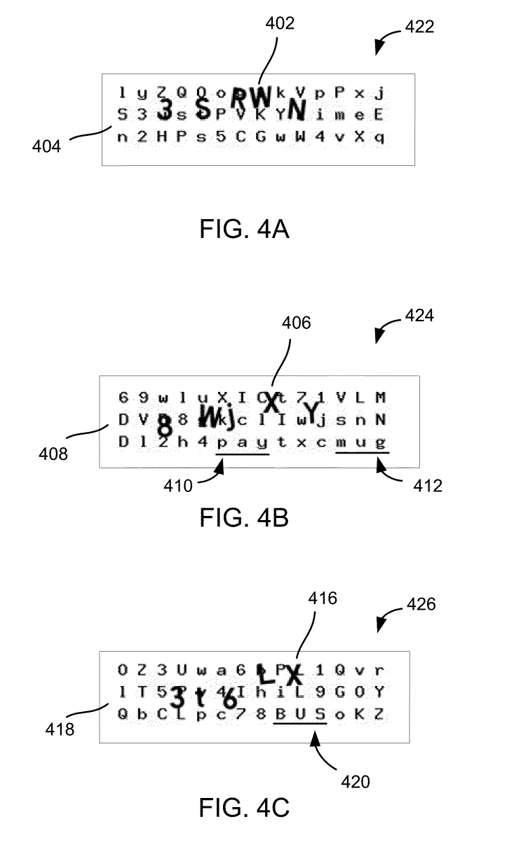

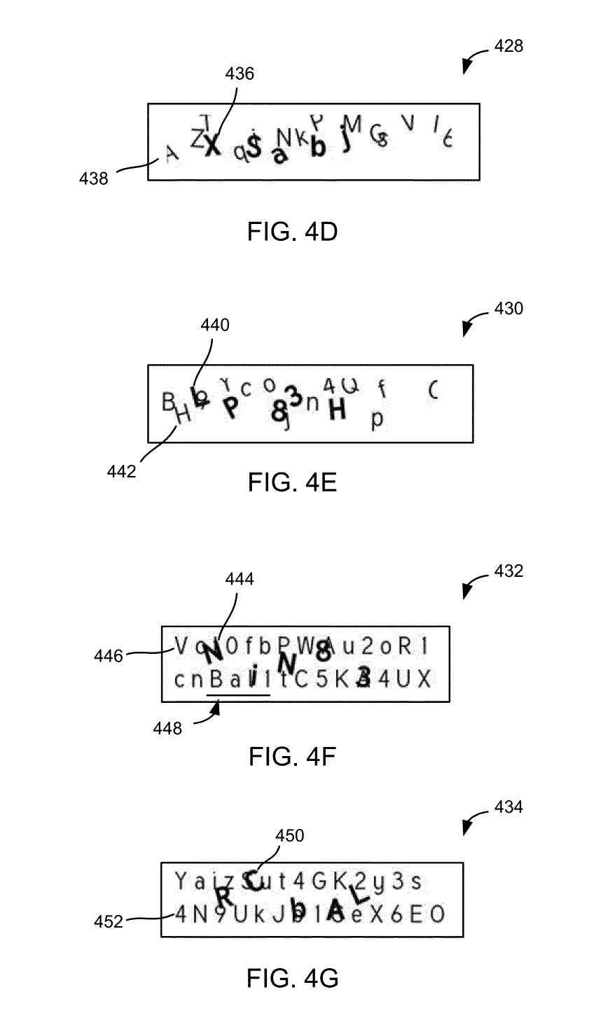

Each decoy code may include characters included within the second character string (e.g., characters included in the second image), or may be formed from a combination of the first and second character strings as the images representing the two strings are combined in the third image (see e.g., FIG. 4F). The decoy code may include a string of characters that is selected or generated to be easily recognized by a computer, so that the decoy code or codes will likely to be recognized by a computer (versus a human). In some embodiments, the computing device 102 may inspect the third image for one or more character strings that are likely to be identified as a CAPTCHA by a program attempting to defeat a CAPTCHA challenge, and designate those identified string or strings as a decoy code or codes associated with the third image. In some embodiments, the computing device 102 may analyze the third image to identify at least one character string that is likely to be recognized by an optical character recognition process attempting to defeat a CAPTCHA challenge-response test, and using the identified character string as the decoy code. In some embodiments, analyzing the third image to identify the at least one character string may include analyzing the third image to identify at least one word appearing within the third image formed by characters from the first image, the second image, or characters formed by a combination of characters from the first image and the second image.

In some embodiments, the decoy code(s) and/or identified string(s) may be used to make the intended correct answer (i.e., the characters corresponding to the character code) less apparent. For example, the decoy character string may be very easy for a computer automated routine to detect (e.g., by using OCR techniques), while the character code associated with the string that is intended as a correct answer may be configured so that the characters are relatively difficult for the computer automated routine to detect. As noted above, the characters intended to be a correct answer (e.g., a first character string) may be distorted (rotated, misshaped, different sizes, different typefaces, etc.) such that recognition of the characters would require image analysis and interpretation beyond usual character recognition algorithms (e.g., OCR). Examples of distortions that may be used with the characters associated with the correct answer to make them difficult to detect by a computer automated routine include presenting the characters in different orientations, different shapes, different sizes, different typefaces, differing numbers of characters, and combinations of any two or more such distortions. Thus, in some embodiments, the correct answer characters may be presented in a distorted fashion that makes the characters unlikely to be recognized by automated character recognition techniques and positioned adjacent to, underneath and/or surrounded by one or more decoy codes presented in a format that is compatible with automated character recognition techniques and thus likely to be recognized.

In block 214, the computing device 102 may present the third image as a verification challenge. For example, the third image may be presented as a verification challenge as part of a challenge-response test. For example, in response to an attempt to access using computing device 102 a service that solicits input from a user, such as an online poll, a registration for a free email address, a comment on an article, web log, or other publication, a registration for an event, and so forth, the computing device 102 may present the third image as a verification challenge to request certain input. The requested input may be indicated by the third image itself, such as by a difference in the presentation of the characters of the first image and the characters of the second image that is readily apparent to a human user, yet relatively difficult to detect for a computer automated routine, while the decoy code or codes included in the third image is selected or configured to be easily recognized by a computer (e.g., an image that is easily processed by a text-recognition program).

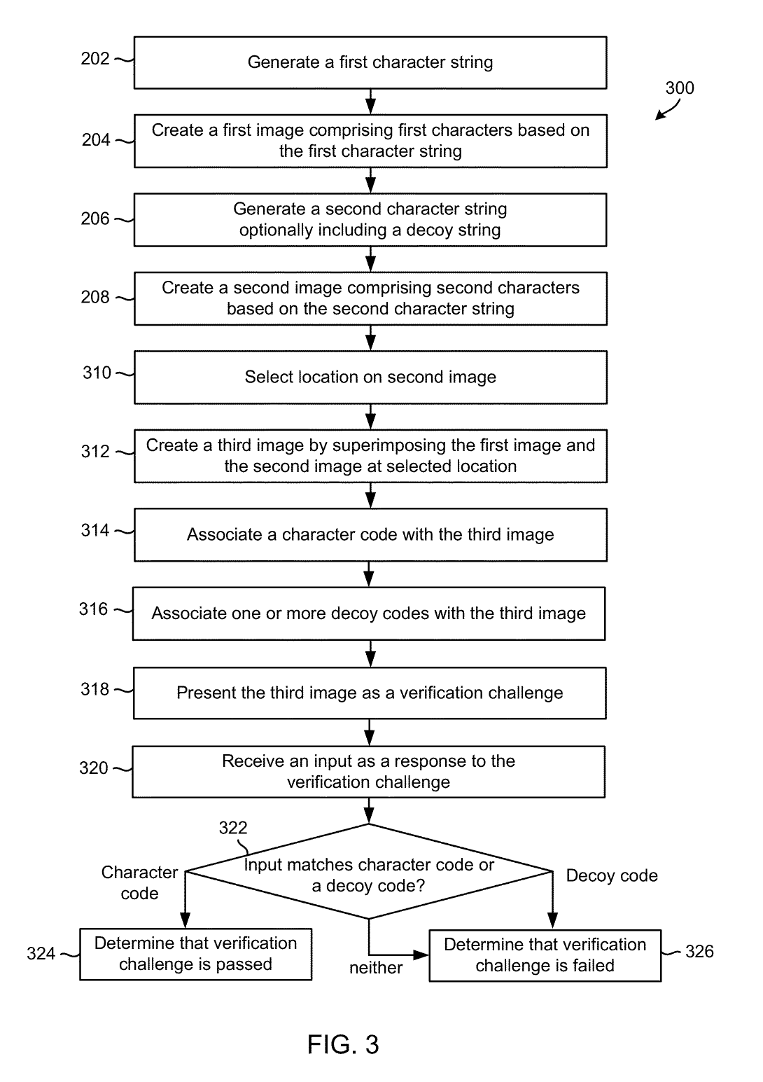

FIG. 3 illustrates a process flow diagram of another example method 300 that may be used by exemplary computing device 102 to prevent an automated computer routine from passing a challenge-response test. The method 300 may include some operations of the method 200, which are described above for like numbered blocks with reference to FIG. 2. In block 202, the computing device 102 may generate a first character string, and in block 204, the computing device 102 may create a first image including first characters based on the first character string. In an embodiment, the generated first character string may include a random sequence of characters. In block 206, the computing device 102 may generate a second character string, which may be a random sequence of characters and may, optionally, include a generated or identified decoy string as described above. In block 208, the computing device 102 may create a second image including second characters based on the second character string.

In block 310, the computing device 102 may select a location on the second image for superimposing the first image. For example, the second image may be a bitmap, and coordinates of the bitmap may be selected. As another example, the second image may be a JPEG, GIF, or other image file, and a point of the image represented by the data of the image file may be selected. In one example, the location may be a randomly selected location.

In block 312, the computing device 102 may create a third image by superimposing the first image at the selected location on the third image. For example, FIG. 4A illustrates a third image 422 that includes a first image 402 and a second image 404. The first image 402 includes first characters “3SRWN”, and the second image 404 includes second characters “lzYQO . . . ” and so forth. The first characters of the first image 402 in FIG. 4A are presented in a relatively large size, boldface type, as compared to the second characters, which are relatively smaller, and not boldfaced. The first characters are further at a different orientation as compared to the second characters. Moreover, the first characters are presented with a different spacing than the second characters. The location of the first image 402 may be selected by computing device 102, to further distinguish the first and second images, for example, by making the location of the first characters relatively unpredictable. It will be appreciated that the presentation of the characters of the first image 402 and the second image 404 are merely exemplary, and that other variations are also possible.

Returning to FIG. 3, in block 314, the computing device 102 then may associate a character code with the third image. The character code may identify the sequence of characters indicating a human response. In some examples, more than one character code may be associated with the third image. The character code may be based on the first character string or the second character string. The character code may be based on a difference between the first and second images that makes one set of characters (e.g., the characters of the first image) relatively more prominent or visually distinct from the other set of characters (e.g., the characters of the second image), such as a difference in orientations, shapes, sizes, typefaces, or numbers of characters. The at least one difference between the characters of the first image and the characters of the second image may be readily apparent to a human user, while such difference may be relatively difficult for a computer automated routine to discern. For example, referring again to FIG. 4A, the character code may define the character string that is represented in first image 402 as characters “3SRWN”.

Referring again to FIG. 3, in block 316, the computing device 102 may associate one or more decoy codes with the third image. The decoy code or codes may be based on the first character string or the second character string. In one example, a decoy code is based on a different character string than the character string representing the character code. The first character string and the second character string may include substantially random characters. One or more portions of the first and/or second character string (or a combination thereof) may include recognizable words, phrases, and the like that are identified or generated to be likely to be “recognized” by a program attempting to defeat a CAPTCHA challenge. The decoy code(s) may be based on a portion of the first and/or second character string including the recognizable words, phrases, and the like.

For example, FIG. 4B illustrates an example third image 424 including a first image 406 and a second image 408. The first image 406 includes first characters “8WjXY”, and the second image 404 includes second characters “69wluX . . . ” and so forth. The first characters of the first image 406 in FIG. 4B are presented in a relatively large size, boldface type, at a wider spacing, and in a different relative orientation as compared to the second characters. As another example, FIG. 4C illustrates an example third image 426 including a first image 416 and a second image 418. The first image 416 includes first characters “3t6LX”, and the second image 418 includes second characters “OZ3Uwa6 . . . ” and so forth. The first characters of the first image 416 in FIG. 4C are presented in a relatively large size, boldface type, at a wider spacing, and in a different relative orientation as compared to the second characters. The presentation of the characters in the respective first and second images of third images 424 and 426 are merely exemplary, and that other variations are also possible.

The decoy code may be based, for example, on a word or phrase that appears in the second image 408, such as the characters “pay” 410 in the second image 408, or on the characters “mug” 412 in the second image 408 of FIG. 4B. As another example, the decoy code may be based, for example, on the characters “BUS” 420 in the second image 418 of FIG. 4C. To enable the inclusion of a detectable word or phrase in the second image 408 or in the second image 418, the character string represented by the second image may include both substantially random characters and one or more decoy characters likely to be recognized as a CAPTCHA string by a program attempting to defeat a CAPTCHA challenge. For example, the decoy characters may be selected from a list of character strings determined in advance as likely to be recognized as a CAPTCHA string or characters determined as being likely to be recognized based on parsing the first and/or second character string.

In an embodiment, the second image may include at least one character string configured to be detected by an optical character recognition process, which may be used by a computer-automated routine. A computing device receiving an input matching the decoy code corresponding to the decoy character string, for example, the decoy code corresponding with the word “pay” and/or the decoy code associated with the word “mug” (as in FIG. 4B), or an input matching the decoy code associated with the word “BUS” (as in FIG. 4C) may determine that the input fails the verification test, and interpret receipt of the decoy code as an indication that the input is from an automated computer routine attempting to defeat the CAPTCHA challenge. The inclusion of one or more decoy codes in the form of a word or phrase in the second image that is configured to be readily detectable by an automated computer routine may enhance protections against an automated computer routine passing the CAPTCHA challenge-response test.

Returning to FIG. 3, in block 318, the computing device 102 may present the third image as a verification challenge. For example, in response to an attempt to access a service that solicits input from a user, such as an online poll, a registration for a free email address, a comment on an article, web log, or other publication, a registration for an event, and so forth, a computing device 102 receiving the access attempt may present the third image as a verification challenge as part of a challenge-response test that must be passed before access is granted. The requested input may be indicated by a difference in the presentation of the characters of the first image and the characters of the second image that is readily apparent to a human user, yet relatively difficult to detect for a computer automated routine. For example, the requested input may be readily determined by a human user to include the characters of image 402 illustrated in FIG. 4A, or the characters of image 406 illustrated in FIG. 4B, or the characters of image 416 illustrated in FIG. 4C.

In block 320 (FIG. 3), the computing device 102 may receive an input as a response to the verification challenge. The input may be received as an HTTP message from a remote computing device or client, a sequence of keystrokes on a keyboard or keypad, an input detected from a mouse, touch screen, or other similar input device, as text encoded from a voice input, and other forms of input. In determination block 322, the computing device 102 may determine whether the received input matches the character code or a decoy code associated with the third image.

In response to determining that the received input matches the character code (i.e., determination block 322=character code), the computing device 102 may determine that the challenge-response test was successfully passed (i.e., verification success) in block 324. For example, referring to FIG. 4A, when the input received in response to the presentation of the third image 422 includes “3SRWN”, the computing device 102 may determine that the verification challenge is passed.

In response to determining that the received input matches a decoy code, or when the received input matches neither the character code nor a decoy code (i.e., determination block 322=either “decoy code” or “neither”), the computing device 102 may determine that verification challenge is failed in block 326 (i.e., the input fails the challenge-response test). For example, when the input received in response to the presentation of third image 424 includes “pay” or “mug” (FIG. 4B), the computing device 102 may determine that the verification challenge is failed. As another example, when the input received in response to the presentation of third image 426 includes “BUS” (FIG. 4C), the computing device 102 may determine that the verification challenge is failed. In addition, the computing device receiving any other input not corresponding to the character code may determine that the verification challenge is failed.

FIGS. 4D-4G illustrate additional examples of third images 428, 430, 432, and 434 that may be created by superimposing a first image and a second image. Each first image and second image may include characters based on a first character string and a second character string, respectively. In an embodiment, each of the first character string and the second character string may include a generated random sequence of characters.

The third image 428 (FIG. 4D) includes a first image 436 and a second image 438. The first image 436 includes first characters “XSabj”, and the second image 438 includes second characters “AZTqjN . . . ” and so forth. The first characters of the first image 436 are presented in a relatively large size and in boldface type, as compared to the second characters, which are relatively smaller and not boldfaced. Each of the first characters and the second characters includes a set of characters (e.g., a single line of characters) that are displayed at substantially random spacing, vertical displacement, and relative orientation. The location of the first image 436 on the second image 438 may be selected by the computing device accordingly to various considerations.

The third image 430 (FIG. 4E) includes a first image 440 and a second image 442. The first image 440 includes first characters “LP83H”, and the second image 442 includes second characters “BH9Yco . . . ” and so forth. In addition to being presented in different type faces and character sizes, each of the first characters and the second characters includes a set of characters that may be displayed at substantially random spacing, vertical displacement, and relative orientation.

The third image 432 (FIG. 4F) includes a first image 444 and a second image 446. The first image 444 includes first characters “NIN83”, and the second image 446 includes second characters “Vol0fb . . . ” and so forth. In the third image 432, the second characters include a two-line background of characters, on which the first image 444 is superimposed. The first characters may be displayed at substantially random spacing, vertical displacement, and relative orientation to each other and to the second characters. The second characters 446 include a sequence 448 of characters “Bal1”, over which the first character “i” is superimposed.

To increase the probability that an automated computer routine may determine an incorrect input as a response to a verification challenge, a decoy code corresponding with the word “Ball” and another decoy code corresponding with the word “Bail” may be associated with the third image 432. The inclusion of a word or phrase in the second image that is configured to be readily detectable by an automated computer routine (e.g., “Ball”) may enhance the prevention of the automated computer routine from passing the challenge-response test.

The superimposition of the first image 444 on the second image 446 may result in a word or phrase (e.g., “Bail”) that may be readily detectable by an automated computer routine attempting to defeat a CAPTCHA test. Thus, computing device 102 may scan the third image to identify characters, words, or phrases created by the superimposition of the characters in the first and second images that are likely to be detected by an optical recognition process attempting to defeat a CAPTCHA test. A corresponding decoy code may be associated with such a word or phrase identified within the superimposition of the first and second images. Thus, one or more decoy codes may be determined by analyzing the third image to identify at least one recognizable word or phrase appearing within the third image formed by a combination of characters from the first image and the second image. In a further embodiment, the computing device 102 may adjust the position of the first image with respect to the second image before generating the superimposed third image in order to create at least one word appearing within the third image formed by a combination of characters from the first image and the second image that is configured to be likely to be “recognized” by an automated routine attempting to defeat a CAPTCHA challenge. Thus in the example presented in FIG. 4F, receipt by the computing device of an input matching either of the decoy codes “Ball” and “Bail” may cause the computing device to fail the verification challenge, and optionally take a defensive action (e.g., refusing to present further verification challenges to a particular IP address) to protect against an automated computer routine attempting to defeat the CAPTCHA test.

The third image 434 (FIG. 4G) includes a first image 450 and a second image 452. The first image 450 includes first characters “RCbAL”, and the second image 452 includes second characters “YaizS . . . ” and so forth. In the third image 434, the second characters include a two-line background of characters, on which the first image 450 is superimposed. The first characters may be displayed at substantially random spacing, vertical displacement, and relative orientation to each other and to the second characters.

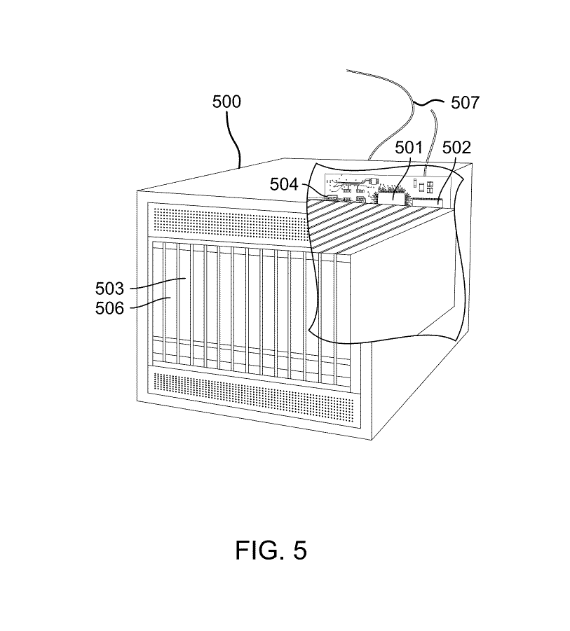

The various embodiments may be implemented on any of a variety of commercially available workstations and server devices, such as the server 500 illustrated in FIG. 5. Such a server 500 typically includes a processor 501 coupled to volatile memory 502 and a large capacity nonvolatile memory, such as a disk drive 503. The server 500 may also include a floppy disc drive, compact disc (CD) or DVD disc drive 506 coupled to the processor 501. The server 500 may also include network access ports 504 coupled to the processor 501 for establishing network interface connections with a network 507, such as a local area network coupled to other announcement system computers and servers, the Internet, the public switched telephone network, and/or a cellular network (e.g., CDMA, TDMA, GSM, PCS, 3G, 4G, LTE, or any other type of cellular network).

The processors 128 and 501 may be any programmable microprocessor, microcomputer or multiple processor chip or chips that may be configured by software instructions (applications) to perform a variety of functions, including the functions of the various embodiments described above. In some devices, multiple processors may be provided, such as one processor dedicated to wireless communication functions and one processor dedicated to running other applications. Typically, software applications may be stored in the internal memory before they are accessed and loaded into the processors 128 and 501. The processors 128 and 501 may include internal memory sufficient to store the application software instructions. In many devices the internal memory may be a volatile or nonvolatile memory, such as flash memory, or a mixture of both. For the purposes of this description, a general reference to memory refers to memory accessible by the processors 128 and 501 including internal memory or removable memory plugged into the device and memory within the processor 128 and 501 themselves.

The foregoing method descriptions and the process flow diagrams are provided merely as illustrative examples and are not intended to require or imply that the operations of the various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the claims.

The hardware used to implement the various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more exemplary embodiments, the functions described may be implemented in hardware, software, firmware, or any combination thereof. If implemented in software, the functions may be stored as one or more instructions or code on a non-transitory computer-readable medium or non-transitory processor-readable medium. The operations of a method or algorithm disclosed herein may be embodied in a processor-executable software module that may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the scope of the claims. Thus, the present invention is not intended to be limited to the embodiments shown herein but is to be accorded the widest scope consistent with the following claims and the principles and novel features disclosed herein.

What is claimed is:

1. A method of preventing an automated computer routine from passing a challenge-response test, comprising:
generating, by a computing device, a first character string and creating a first image comprising first characters based on the first character string;
generating, by the computing device, a second character string and creating a second image comprising second characters based on the second character string;
creating, by the computing device, a third image by superimposing the first image and the second image;
associating, by the computing device, a first character code based on the first character string with the third image;
associating, by the computing device, at least one decoy code with the third image, wherein the at least one decoy code is based on one or more characters within the third image that are likely to be detected by an automatic character recognition process;
presenting, by the computing device, the third image as a verification challenge; and
determining, by the computing device, that the verification challenge is failed in response to receiving a verification challenge response that matches the decoy code.

2. The method of claim 1, wherein the first characters of the first image are configured to be unlikely to be detected by the automatic character recognition process.

3. The method of claim 2, wherein the first characters of the first image are presented in at least one of different orientations, different shapes, different sizes, different typefaces, and differing numbers of characters than the second characters of the second image to make the first characters difficult to detect by a computer automated routine.

4. The method of claim 1, wherein generating the second character string comprises generating a substantially random sequence of characters.

5. The method of claim 4, wherein generating the second character string comprises including in the substantially random sequence of characters at least one character string configured to be detected by an automatic character recognition process attempting to defeat a Completely Automated Public Turing Test To Tell Computers and Humans Apart (CAPTCHA) challenge, and wherein the decoy code represents the at least one character string included in the second character string.

6. The method of claim 4, further comprising analyzing the substantially random sequence of characters to identify at least one character string that is likely to be recognized by an automatic character recognition process attempting to defeat a Completely Automated Public Turing Test To Tell Computers and Humans Apart (CAPTCHA) challenge, wherein the decoy code represents the identified at least one character string.

7. The method of claim 6, wherein analyzing the substantially random sequence of characters comprises analyzing the substantially random sequence of characters to identify at least one word appearing within the random sequence of characters.

8. The method of claim 1, further comprising analyzing the third image to identify at least one character string that is likely to be recognized by an optical character recognition process attempting to defeat a Completely Automated Public Turing Test To Tell Computers and Humans Apart (CAPTCHA) challenge-response test, wherein the decoy code represents the identified at least one character string.

9. The method of claim 8, wherein analyzing the third image to identify the at least one character string comprises analyzing the third image to identify at least one word appearing within the third image formed by characters from the first image, the second image, or characters formed by a combination of characters from the first image and the second image.

10. The method of claim 1, wherein creating the third image by superimposing the first image and the second image comprises creating the third image so that at least one character is formed from superimposition of characters within the first and second images that is configured to be detected by an automatic character recognition process.

11. The method of claim 1, further comprising:
determining that that the verification challenge is passed in response to receiving a verification challenge response that matches the first character code.

12. The method of claim 1, wherein creating a third image by superimposing the first image and the second image comprises creating the third image by superimposing the first image at a randomly selected location on the second image.

13. A computing device, comprising:
a processor configured with processor-executable instructions to perform operations comprising:
generating a first character string and creating a first image comprising first characters based on the first character string;
generating a second character string and creating a second image comprising second characters based on the second character string;
creating a third image by superimposing the first image and the second image;
associating a first character code based on the first character string with the third image;
associating at least one decoy code with the third image, wherein the at least one decoy code is based on one or more characters within the third image that are likely to be detected by an automatic character recognition process;
presenting the third image as a verification challenge; and
determining that the verification challenge is failed in response to receiving a verification challenge response that matches the decoy code.

14. The computing device of claim 13, wherein the processor is configured with processor-executable instructions to perform operations such that the first characters of the first image are configured to be unlikely to be detected by the automatic character recognition process.

15. The computing device of claim 14, wherein the processor is configured with processor-executable instructions to perform operations such that the first characters of the first image are presented in at least one of different orientations, different shapes, different sizes, different typefaces, and differing numbers of characters to make the first characters difficult to detect by a computer automated routine.

16. The computing device of claim 13, wherein the processor is configured with processor-executable instructions to perform operations such that generating the second character string comprises generating a substantially random sequence of characters.

17. The computing device of claim 16, wherein the processor is configured with processor-executable instructions to perform operations such that generating the second character string comprises including in the substantially random sequence of characters at least one character string configured to be detected by an automatic character recognition process attempting to defeat a Completely Automated Public Turing Test To Tell Computers and Humans Apart (CAPTCHA) challenge, and the decoy code represents the at least one character string included in the second character string t.

18. The computing device of claim 16, wherein the processor is configured with processor-executable instructions to perform operations further comprising analyzing the substantially random sequence of characters to identify at least one character string that is likely to be recognized by an automatic character recognition process attempting to defeat a Completely Automated Public Turing Test To Tell Computers and Humans Apart (CAPTCHA) challenge, wherein the decoy code represents the identified at least one character string.

19. The computing device of claim 18, wherein the processor is configured with processor-executable instructions to perform operations such that analyzing the substantially random sequence of characters comprises analyzing the substantially random sequence of characters to identify at least one word appearing within the random sequence of characters.

20. The computing device of claim 13, wherein the processor is configured with processor-executable instructions to perform operations further comprising analyzing the third image to identify at least one character string that is likely to be recognized by an optical character recognition process attempting to defeat a CAPTCHA challenge-response test, wherein the decoy code represents the identified at least one character string.

21. The computing device of claim 20, wherein the processor is configured with processor-executable instructions to perform operations such that analyzing the third image to identify the at least one character string comprises analyzing the third image to identify at least one word appearing within the third image formed by characters from the first image, the second image, or characters formed by a combination of characters from the first image and the second image.

22. The computing device of claim 13, wherein the processor is configured with processor-executable instructions to perform operations such that creating the third image by superimposing the first image and the second image comprises creating the third image so that at least one character is formed from superimposition of characters within the first and second images that is configured to be detected by an automatic character recognition process.

23. The computing device of claim 13, wherein the processor is configured with processor-executable instructions to perform operations further comprising:
determining that that the verification challenge is passed in response to receiving a verification challenge response that matches the first character code.

24. The computing device of claim 13, wherein the processor is configured with processor-executable instructions to perform operations such that creating a third image by superimposing the first image and the second image comprises creating the third image by superimposing the first image at a randomly selected location on the second image.

25. A non-transitory processor-readable storage medium having stored thereon processor-executable software instructions configured to cause a processor to perform operations for preventing an automated computer routine from passing a challenge-response test, comprising:
generating, by a computing device, a first character string and creating a first image comprising first characters based on the first character string;
generating, by the computing device, a second character string and creating a second image comprising second characters based on the second character string;
creating, by the computing device, a third image by superimposing the first image and the second image;
associating, by the computing device, a first character code based on the first character string with the third image;
associating, by the computing device, at least one decoy code with the third image, wherein the at least one decoy code is based on one or more characters within the third image that are likely to be detected by an automatic character recognition process;
presenting, by the computing device, the third image as a verification challenge; and
determining, by the computing device, that the verification challenge is failed in response to receiving a verification challenge response that matches the decoy code.

26. The non-transitory processor-readable storage medium of claim 25, wherein the stored processor-executable software instructions are configured to cause a processor to perform operations such that the first characters of the first image are configured to be unlikely to be detected by the automatic character recognition process.

27. The non-transitory processor-readable storage medium of claim 25, wherein the stored processor-executable software instructions are configured to cause a processor to perform operations such that the first characters of the first image are presented in at least one of different orientations, different shapes, different sizes, different typefaces, and differing numbers of characters to make the first characters difficult to detect by a computer automated routine.

28. A computing device, comprising:
means for generating a first character string and creating a first image comprising first characters based on the first character string;
means for generating a second character string and creating a second image comprising second characters based on the second character string;
means for creating a third image by superimposing the first image and the second image;
means for associating a first character code based on the first character string with the third image;
means for associating at least one decoy code with the third image, wherein the at least one decoy code is based on one or more characters within the third image that are likely to be detected by an automatic character recognition process;
means for presenting the third image as a verification challenge; and
means for determining that the verification challenge is failed in response to receiving a verification challenge response that matches the decoy code.

29. The computing device of claim 28, wherein the first characters of the first image are configured to be unlikely to be detected by the automatic character recognition process.

30. The computing device of claim 28, wherein the first characters of the first image are presented in at least one of different orientations, different shapes, different sizes, different typefaces, and differing numbers of characters to make the first characters difficult to detect by a computer automated routine.
